(19) United States
(12) Patent Application Publication
(10) Pub. No.: US 2009/0166295 A1
(43) Pub. Date: Jul. 2, 2009

(54) ADSORPTIVE ION-EXCHANGE MATERIAL AND METHOD FOR FILTERING METAL IONS USING THE MATERIAL

(76) Inventors: Wen-Yi CHEN, Kaohsiung County (TW); Shu-Hui Cheng, Hsinchu County (TW)

Correspondence Address: Muncy, Geissler, Olds & Lowe, PLLC, P.O. BOX 1364, FAIRFAX, VA, 22038-1364, US

(21) Appl. No.: 12/247,646

(22) Filed: Oct. 8, 2008

(30) Foreign Application Priority Data
Dec. 31, 2007 (TW) 96151448

(51) Int. Cl. C02F 1/42; B01J 39/20; C08J 5/20

(52) U.S. Cl. 210/681; 521/38; 521/29

(57) ABSTRACT

The invention discloses an adsorptive ion-exchange material, including a polymer of formulas land II. The material has adsorption ability as well as ion-exchange ability for absorbing metal ions, and can be directly spun into fibers of varying diameters. The invention also discloses a method for treating wastewater containing metal ions using the disclosed adsorptive ion-exchange material.

### CROSS REFERENCE TO RELATED APPLICATIONS

This Application claims priority of Taiwan Patent Application No. 96151448, filed on Dec. 31, 2007, the entirety of which is incorporated by reference herein.

### BACKGROUND OF THE INVENTION

1. Field of the Invention

The present invention relates to an ion-exchange material, and in particular relates to an ion-exchange material having high ion adsorptive capacity and a method for filtering metal ions using the disclosed adsorptive ion-exchange material.

2. Description of the Related Art

Recently, driven by the fast growth of industries, processes such as electroplating, photoelectron, printed circuit board and semiconductor processes have resulted in increased pollutant and wastewater with metal ions. Wastewater with metal ions, if not treated properly, may have a serious impact on the environment and human beings. Therefore, the treatment of metal ions has become very important.

At present, the methods for treatment of metal ions in wastewater include air evaporation, ion-exchange resin, electrodialysis, and electrolysis. Among the treatment methods, the ion-exchange resin method has advantages including cheap, fast mass-transport, high selectivity, reusability of solvent and simple operation and system. However, as the active sites are located in the inner portion of the ion-exchange resin, the longer ion diffusion path length results in limited ion-exchange capacity. Therefore, ion-exchange fiber has been developed in recent years. Because of higher surface area and easy processing, the fiber exhibits higher ion-exchange capacity than conventional resins.

There are some commercially available ion-exchange fibers. A polyvinyl alcohol (PVA) based fiber is disclosed in U.S. Pat. Nos. 4,125,486 and 4,264,676, issued to Nitivity Company, Japan. PVA is cross-linked first at high temperature then sulfonated by sulfuric acid. The ion-exchange fiber with ion-exchange capacity of 2 to 4 meq/g is obtained by the disclosure. The fiber of Tory Company in Japan is a PP/PS core/sheath fiber produced by conjugate spinning. The fibers were then sulfonated with sulfuric acid to obtain an ion-exchange fiber having ion-exchange capacity of 2 meq/g. The fiber of IFOCH NASB in Russia is produced by treating polypropylene (PP) or polyacrylonitrile (PAN) fiber with sulfuric acid to obtain an ion-exchange fiber having ion-exchange capacity of 2-6 meq/g.

The ion-exchange ability of the above described materials is provided by grafting (or modifying) specific functional groups on fiber surface. However, the supporting part of the fibers has no or limited ion-exchange ability, thus limiting overall ion-exchange capacity. Furthermore, fabrication methods of the fibers require funtionalization of fiber after it is spun, which is a complicated and cost process. Accordingly, there is a need to develop an ion-exchange material with high ion-exchange capacity, which can be directly spun to form ion-exchange fiber.

### BRIEF SUMMARY OF THE INVENTION

An object of the present invention is to provide an adsorptive ion-exchange material with adsorption ability as well as ion-exchange ability, therefore providing high ion-exchange capacity.

Another object of the present invention is to provide a method for filtering metal ions by using the disclosed adsorptive ion-exchange material.

In accordance with the object, the ion-exchange material of the present invention comprises a polymer having repeating units of formulas (I) and (II):

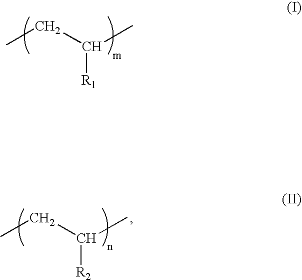

wherein R₁ is phenyl sulfonate or alkyl sulfonate and R₂ is selected from the group consisting of:

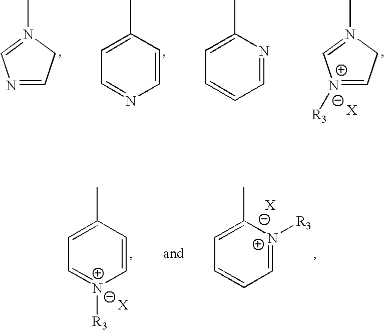

wherein R₃ is C1-C7 alkyl, amine, amide, carboxy or sulfonate, X is chloride, bromide, or iodine, m and n are the number of repeating units, and m/n is between 1/99 and 99/1.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a comparative graph showing the ion-exchange capacity of Example I and Example 2 for filtering of metal ions in varying pH values.

### DETAILED DESCRIPTION OF THE INVENTION

The present invention provides an ion-exchange material with adsorption and ion-exchange ability by functional group design of the monomer. The present invention comprises a polymer having repeating units of formulas (I) and (II):

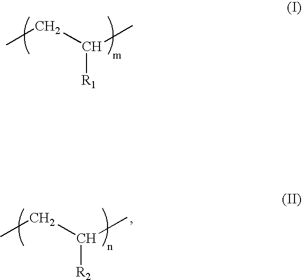

wherein R₁ is phenyl sulfonate or alkyl sulfonate and R₂ is selected from the group consisting of:

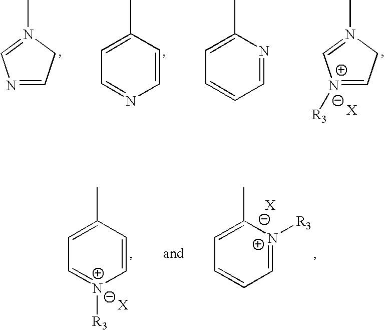

where R₃ is C1-C7 alkyl, amine, amide, carboxy or sulfonate, X is chloride, bromide, or iodine, m and n are the number of repeating units, and m/n is between 1/99 and 99/1.

Because there are nitrogen, sulfur and oxygen atoms in the molecular structure of the polymer, the polymer has both adsorption and ion-exchange ability. The disclosed adsorptive ion-exchange material can be fabricated and processed to the form of a thin film or fibers. For example, a thin film can be produced from the synthesized polymer. Further, an ion-exchange composite fiber can be made by dipping a non-woven cloth in the polymer solution.

The polymer can also react with a cross-linker (such as epoxy resin or di-halogen compound) to obtain a cross-linking structure.

If the molecular weight of the polymer is larger than about 500,000, the polymer can be directly spun into ion-exchange fibers without further modification as in conventional methods.

The fiber of the invention is produced as follows. First monomers are synthesized and the synthesized monomers are polymerized. Finally, the fiber of varying diameter (about 0.1 μm-100 μm) is obtained by spinning techniques. The spinning techniques include dry spinning, wet spinning, solution spinning, jet spinning or electrospinning. Solution spinning and electrospinning are particularly preferably.

The present invention also provides a method for treating waste water containing metal ions using the disclosed adsorptive ion-exchange material. The adsorptive ion-exchange material may be applied in various fields to recover metal ions such as industrial treatment systems, and agricultural or nuclear power plant recycled water treatment systems. In general, the material has an ion-exchange capacity of about 2-17 meq/g for absorbing of metal ions.

The following description is of the best-contemplated mode of carrying out the invention. This description is made for the purpose of illustrating the general principles of the invention and should not be taken in a limiting sense. The scope of the invention is best determined by reference to the appended claims.

### EXAMPLE

### Example 1

20.0 g of sodium styrenesulfate, 10.0 g of 4-vinyl pyridine, 1.0 g of sodium dodecyl sulfate (SDS) and 100.0 g of deionized water were dissolved in a reaction flask, stirred under N₂ atmosphere at 70° C. A solution containing 0.3 g of potassium persulfate (KPS) in 10 mL of deionized water was slowly added into the reaction flask, kept at 70° C. for 3 hours. After the polymerization reaction was completed, deionized water was added into the reaction flask to dilute the solution. The diluted polymer was dripped into a sodium hydroxide (NaOH) solution for re-precipitation. After purification, 29 g polymer was obtained. (molecular weight=899,599 g/mole)

### Example 2

10.0 g of sodium styrenesulfate, 20.0 g of 4-vinyl pyridine, 2.0 g of sodium dodecyl sulfate (SDS) and 100.0 g of deionized water were dissolved in a reaction flask, stirred under N₂ atmosphere at 70° C. A solution containing 0.3 g of potassium persulfate (KPS) in 10 mL of deionized water was slowly added into the reaction flask, kept at 70° C. for 3 hours. After the polymerization reaction was completed, deionized water was added into the reaction flask to dilute the solution. The diluted polymer was dripped into a sodium hydroxide (NaOH) solution for re-precipitation. After purification, 28.7 g polymer was obtained. (molecular weight=648,596 g/mole)

### Example 3

10.0 g of sodium styrenesulfate, 10.0 g of 1-vinyl imidazole, 1.0 g of sodium dodecyl sulfate (SDS) and 100.0 g of deionized water were dissolved in a reaction flask, stirred under N₂ atmosphere at 70° C. A solution containing 0.2 g of potassium persulfate (KPS) in 10 mL of deionized water was slowly added into the reaction flask, kept at 70° C. for 3 hours. After the polymerization reaction was completed, deionized water was added into the reaction flask to dilute the solution. The diluted polymer was dripped into a sodium hydroxide (NaOH) solution for re-precipitation. After purification, 18.4 g polymer was obtained. (molecular weight=530,000 g/mole)

### Example 4

15.0 g of 2-Methyl-2-propene-1-sulfonic acid sodium salt, 10.0 g of 4-vinyl pyridine, 1.0 g of sodium dodecyl sulfate (SDS) and 100.0 g of deionized water were dissolved in a reaction flask, stirred under N₂ atmosphere at 70° C. A solution containing 0.25 g of potassium persulfate (KPS) in 10 mL of deionized water was slowly added into the reaction flask, kept at 70° C. for 3 hours. After the polymerization reaction was completed, deionized water was added into the reaction flask to dilute the solution. The diluted polymer was dripped into a sodium hydroxide (NaOH) solution for re-precipitation. After purification, 24 g polymer was obtained.

### Example 5

15.0 g of 2-Methyl-2-propene-1-sulfonic acid sodium salt, 10.0 g of 1-vinyl imidazole, 1.0 g of sodium dodecyl sulfate (SDS) and 100.0 g of deionized water were dissolved in a reaction flask, stirred under N₂ atmosphere at 70° C. A solution containing 0.25 g of potassium persulfate (KPS) in 10 mL of deionized water was slowly added into the reaction flask, kept at 70° C. for 3 hours. After the polymerization reaction was completed, deionized water was added into the reaction flask to dilute the solution. The diluted polymer was dripped into a sodium hydroxide (NaOH) solution for re-precipitation. After purification, 23.5 g polymer was obtained.

### Example 6

10.0 g of the polymer of Example 1, 1.0 g of 2-chloro-acetamide, 100.0 g of N,N-dimethyl-acetamide (DMAc) were stirred in a reaction flask under N₂ atmosphere at 60° C. for 24 hours. After the polymerization reaction was completed, the diluted polymer was dripped into a sodium hydroxide (NaOH) solution for re-precipitation. After purification, 10.4 g polymer was obtained.

### Example 7

10.0 g of the polymer of Example 1, 0.8 g of 2-chloro-acetamide, 100.0 g of N,N-dimethyl-acetamide (DMAc) were stirred in a reaction flask under N₂ atmosphere at 60° C. for 24 hours. After the polymerization reaction was completed, the diluted polymer was dripped into a sodium hydroxide (NaOH) solution for re-precipitation. After purification, 10.3 g polymer was obtained.

### Example 8

10.0 g of the polymer of Example 1, 1.2 g of 3-chloro-propyl sulfonate, 100.0 g of N,N-dimethyl-acetamide (DMAc) were stirred in a reaction flask under N₂ atmosphere at 60° C. for 24 hours. After the polymerization reaction was completed, the diluted polymer was dripped into a sodium hydroxide (NaOH) solution for re-precipitation. After purification, 10.5 g polymer was obtained.

### Example 9

The polymer of Example 1 was dissolved in a mixed solvent of N,N-dimethyl-acetamide (DMAc) and tetrahydrofuran (THF) to provide a 10% spinning solution. The ion-exchange fiber was obtained by electrospinning, with the applied voltage of 39 KV, spray amount of 75 μL/min/hole, and the distance between the collector and spinneret was 20 cm. The ion-exchange fiber was placed in a copper sulfate solution (pH=5). After 7 hours, the ion-exchange capacity for copper ions was measured and the result is shown in Table 1.

### Example 10

The polymer of Example 1 was dissolved in a mixed solvent of N,N-dimethyl-acetamide (DMAc) and tetrahydrofuran (THF) to provide a 10% spinning solution. The ion-exchange fiber was obtained by solution spinning, with the feed rate of 4 cc/min, and pressure of 8 kg/cm², and the distance between the collector and spinneret was 60 cm.

### Example 11

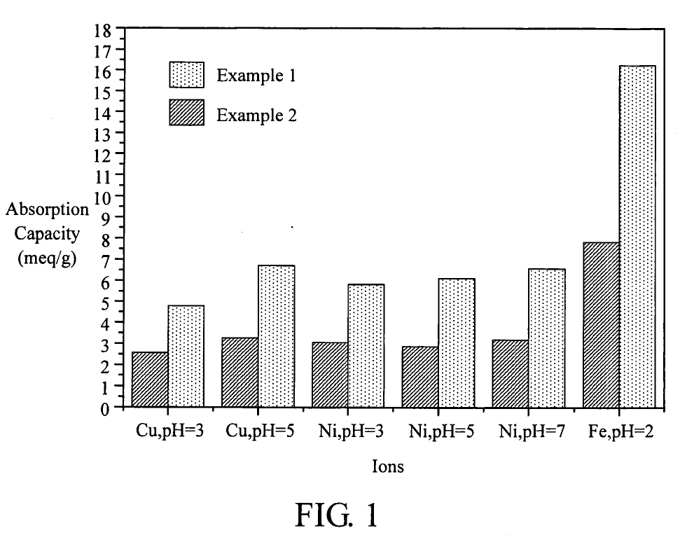

The polymers of Example 1 and Example 2 were dissolved in a 40 mL of solution containing metal ions. (copper ion: 321 ppm (pH=3), 341 ppm (pH=5); nickel ions: 325 ppm (pH=3), 324 ppm (pH=5), 325 ppm (pH=3); ferric ions: 207 ppm (pH=2)) FIG. 1 shows the ion-exchange capacity of the polymers of Example 1 and Example 2 for filtering of metal ions.

### Comparative Example 1

A commercially available ion-exchange fiber IFOCH NASB K-1 was placed in a copper sulfate solution (pH=5). After 7 hours, the ion-exchange capacity of the fiber for copper ions was measured and the result is shown in Table 1.

### Comparative Example 2

A commercially available ion-exchange fiber DIAION® UBK 08 was placed in a copper sulfate solution (pH=5). After 7 hours, the ion-exchange capacity of the fiber for copper ions was measured and the result is shown in Table 1.

Table 1 summarizes the ion-exchange capacity of the polymers of Example 9, Comparative Example 1 and Comparative Example 2. As shown in Table 1, the fiber of the invention exhibited improved ion-exchange capacity over commercial fibers.

TABLE 1
ion-exchange capacity

| sample | Cu (pH = 5)Meq/g |
|---|---|
| Example 9 | 5.57 |
| Comparative Example 1 | 3.32 |
| Comparative Example 2 | 0.8 |

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An adsorptive ion-exchange material, comprising a polymer having repeating units of formulas (I) and (II): 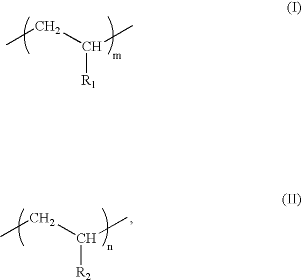
wherein R₁ is phenyl sulfonate or alkyl sulfonate and R₂ is selected from the group consisting of: 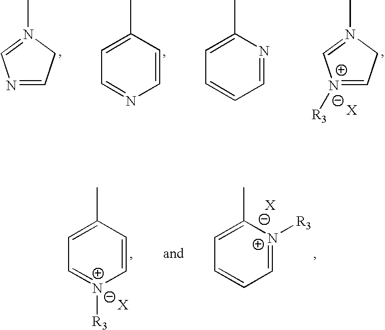
where R₃ is C1-C7 alkyl, amine, amide, carboxy or sulfonate, X is chloride, bromide or iodine, m and n are the number of repeating units, and m/n is between 1/99 and 99/1.

2. The adsorptive ion-exchange material as claimed in claim 1, wherein the adsorptive ion-exchange material has a cross-linking structure.

3. The adsorptive ion-exchange material as claimed in claim 1, wherein the adsorptive ion-exchange material has an ion-exchange capacity of about 2-17 meq/g.

4. The adsorptive ion-exchange material as claimed in claim 1, wherein the adsorptive ion-exchange material is in the form of a film or fiber.

5. The adsorptive ion-exchange material as claimed in claim 4, wherein the fiber has a molecular weight larger than about 500,000.

6. The adsorptive ion-exchange material as claimed in claim 4, wherein the fiber is made by dry spinning, wet spinning, solution spinning, jet spinning or electrospinning.

7. The adsorptive ion-exchange material as claimed in claim 4, wherein the fiber has a diameter between about 0.1 μm and 100 μm.

8. A method for treating a solution containing metal ions with the adsorptive ion-exchange material as claimed in claim 1.

9. The method for absorbing metal ions as claimed in claim 8, wherein the adsorptive ion-exchange material has an ion-exchange capacity of about 2-17 meq/g.
